(19) United States
(12) Patent Application Publication
(10) Pub. No.: US 2016/0166116 A1
(43) Pub. Date: Jun. 16, 2016

(54) FOOD PREPARATION APPARATUS AND METHOD

(71) Applicant: Panera, LLC, St. Louis, MO (US)

(72) Inventors: Dan Kish, Millbrook, NY (US); Jeff Watson, Franklin, TN (US)

(73) Assignee: Panera, LLC, St. Louis, MO (US)

(21) Appl. No.: 14/568,063

(22) Filed: Dec. 11, 2014

(51) Int. Cl. A47J 47/02; B65D 25/56; B65D 53/02; B65D 81/32; B65D 25/04; B65D 43/02

(52) U.S. Cl. CPC A47J 47/02; B65D 25/04; B65D 43/0204; B65D 53/02; B65D 81/32; B65D 25/56; A47J 2203/00

(57) ABSTRACT

A method and apparatus for combining food items is disclosed. A food preparation system includes a container, a lid and a divider. The container includes first and second sections for holding food items, the first and second sections defined at least in part by the divider. The divider includes a first partition and, in some embodiments, further includes a partition support The partition support includes at least two compartment for receiving food items. In some embodiments, the lid has have a volume equal to or greater than the sum of a first volume of the first section and a second volume of the second section.

### FIELD

The disclosed embodiments are generally directed to apparatuses and methods for measuring and/or combining food items.

### BACKGROUND

Various types of household and commercial devices are used to prepare food items which include multiple ingredients, such as salads. In many instances, measuring cups and/or scales are used to measure ingredients, and the ingredients are then added to a bowl or other container. For example, salads are often prepared with a mixing bowl and measuring cups and spoons.

### SUMMARY

According to one embodiment, a method of combining food items using a container and a divider positioned in the container to form container sections is disclosed. The method includes adding a first food item to a first section of the container until the first food item reaches a first indicator on one of the container and the divider, adding a second food item to a second section of the container until the second food item reaches a second indicator on one of the container and the divider, attaching a lid to the container, and mixing the food items within a volume defined by the container and the lid.

According to another embodiment, an apparatus for combining food items is disclosed. The apparatus includes a container with first and second sections to hold food items, the first and second sections being defined at least in part by a divider having a first partition, and a lid attachable to the container. The first section has a first volume, the second section has a second volume, and the lid has a volume equal to or greater than the sum of the first and second volumes.

According to still another embodiment, an apparatus for combining food items is disclosed. The apparatus includes a container and first and second removable dividers, the container being configured to accept either one of the first and second dividers. Each of the first and second dividers includes a partition which does not reach a rim of the container when the respective divider is positioned in the container in a use position.

According to another embodiment, an apparatus for combining food items is disclosed. The apparatus includes a container, first and second removable dividers, the container being configured to accept either one of the first and second dividers, and a lid. When the first removable divider is positioned in the container, the container has first and second sections to hold food items, the first and second sections are defined at least in part by the first removable divider, the first section having a first volume and the second section having a second volume, the lid having a volume equal to or greater than the sum of the first and second volumes. When the second removable divider is positioned in the container, the container has third and fourth sections to hold food items, the third and fourth sections are defined at least in part by the second removable divider, the third section having a third volume and the fourth section having a fourth volume, the lid having a volume equal to or greater than the sum of the third and fourth volumes.

According to yet another embodiment, a divider for use with a first container and a lid to combine food items is disclosed. The divider includes a first partition and a second container having at least two compartments. The second container is attached to the first partition.

According to another embodiment, a method of combining food items using a container and a plurality of removable dividers is disclosed. The method includes selecting a first divider, positioning the first divider within the container such that the container has first and second sections to hold food items, the first and second sections being defined at least in part by the first divider, adding food items to each of the first and second sections, and mixing the food items.

According to still another embodiment, a method of combining food items using a container and a divider is disclosed. The container has first and second sections for holding food items, the first and second sections being defined at least in part by the divider. The divider has a partition support with at least two compartments and a first partition connected to the partition support. The method includes adding a first food item to one of the at least two compartments, adding a second food item to one of the at first and second sections, and mixing the food items.

It should be appreciated that the foregoing concepts, and additional concepts discussed below, may be arranged in any suitable combination, as the present disclosure is not limited in this respect.

The foregoing and other aspects, embodiments, and features of the present teachings can be more fully understood from the following description in conjunction with the accompanying drawings.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 is a perspective view of a food preparation system according to one embodiment;

FIG. 2 is a perspective view of a container of a food preparation system according to one embodiment;

FIG. 3 is a perspective view of a lid of a food preparation system according to one embodiment;

FIG. 4 a perspective view of a food preparation system according to another embodiment;

FIG. 5 is a perspective view of a food preparation system according to still another embodiment;

FIG. 6 is a perspective view of a divider according to one embodiment;

FIG. 7A is a perspective view of a divider according to another embodiment;

FIG. 7B is a perspective view of a divider according to still another embodiment;

FIG. 8 is a perspective view of a container of a food preparation system according to one embodiment;

FIG. 9 is a perspective view of a food preparation system according to another embodiment;

FIG. 10 is a perspective view of a food preparation system according to still another embodiment;

FIG. 11 is a perspective view of the food preparation system of FIG. 10, with a lid attached to a container; and

FIG. 12 is a schematic representation of a method of using a food preparation system according to one embodiment.

### DETAILED DESCRIPTION

To prepare a food dish, whether it be at home or in a restaurant, an individual typically uses a measuring device (e.g., measuring cups, measuring spoons, or a scale) to measure the food ingredients, and combines and mixes the ingredients either by hand with a mixing bowl and cutlery (e.g., a mixing spoon) or with a mixing appliance (e.g., a food processor or a mixer). This process can require many different tools and steps to prepare the dish and can also lead to inconsistencies in preparation. For example, if a chef attempts to save time by not using measuring devices, inconsistent ratios of the ingredients may result. The inconsistency may be problematic in dining establishments where the same food dishes need to be prepared consistently and quickly. Applicant has recognized that through the use of a food preparation system that can quickly and consistently measure and combine food items, various advantages may be realized.

According to one aspect, an apparatus for measuring and combining food items is disclosed. In one embodiment, a container has first and second sections for holding food items, the first and second sections being defined at least in part by a divider having a first partition. The first and second sections of the container have first and second volumes, respectively, which are configured to accommodate a target volume of the first and second food items for the particular dish that is being prepared. For example, in an embodiment in which a Caesar salad is being prepared, the first volume may be sized to accommodate a target volume of lettuce for a single serving and the second volume may be sized to accommodate the target volume of parmesan cheese. As will be appreciated, in some embodiments, the first and second sections may be used to accommodate the same food item (e.g., two portions of lettuce). In these embodiments, the first and second sections help the user add the correct ratio or portion of the first and second food items. As a result, in some embodiments, the apparatus is an all-in-one device that allows for self-measuring and quick and accurate food preparation with fewer tools than are typically used. In some embodiments, the apparatus allows for an easier and faster clean-up in view of the reduced number of tools used. The apparatus also may include a lid that is attachable to the container.

Although many of the embodiments described herein are described in relation to the preparation of a lettuce-based salad, it should be appreciated that other types of salads and other food dishes may be prepared using the apparatus. For example, the apparatus may be used to prepare dishes with noodles, grains (e.g., quinoa), beans, or other wet and dry food items.

According to another aspect, a method of combining food items is disclosed. In one embodiment, the method includes adding a first food item to the first section of a container and adding a second food item to the second section of the container. In some embodiments, adding the first and second food items to the container includes adding each of the first and second food items to its respective container section until each of the food items reaches an indicator. Each indicator may be a top of a wall that divides the container into sections such that food is added until the container section is filled up to the top of the divider wall. The indicator also may include a printed, horizontal line, a protrusion or recess on a wall, or any other suitable indicator. The method further includes attaching a lid to the container and mixing the first and second food items within the container and attached lid. In some embodiments, mixing the first and second food items includes holding and shaking the closed container. As will be appreciated, in some embodiments, shaking the container allows for an even mixing of the food items and/or an even coating of the food items (e.g., an even coating of a salad dressing or sauce on the other food items).

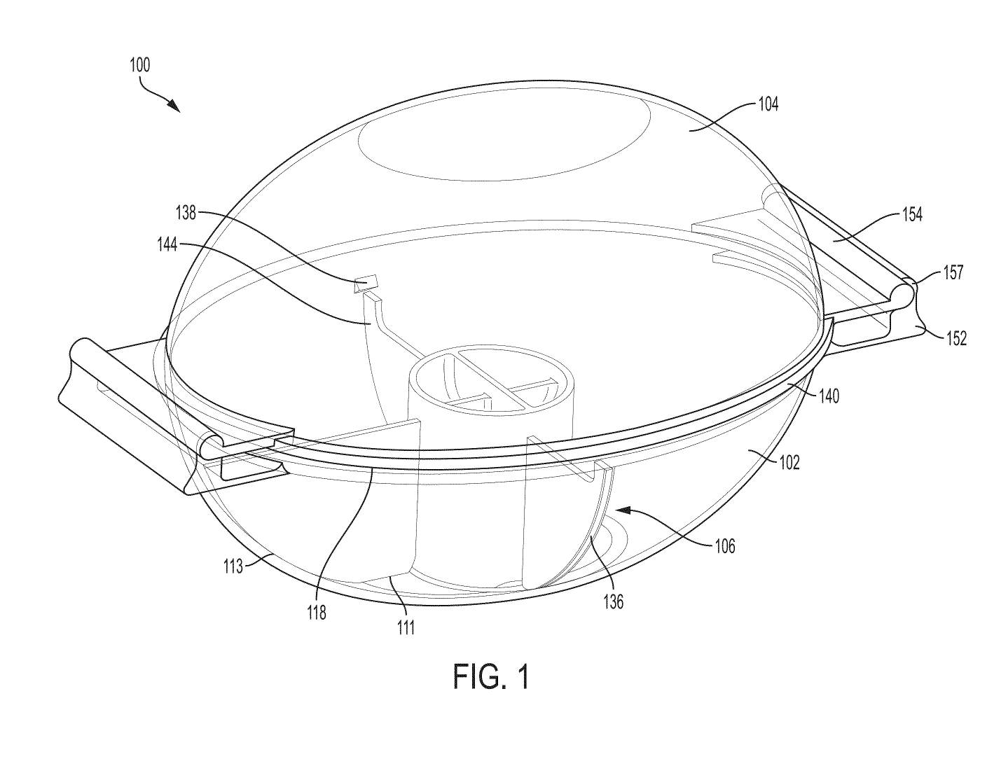

As shown in FIG. 1, in one embodiment, a food preparation system 100 includes a container 102, a lid 104, and a divider 106. In some embodiments, the divider 106 includes one or more partitions, which, as previously described, at least in part define the sections of the container 102.

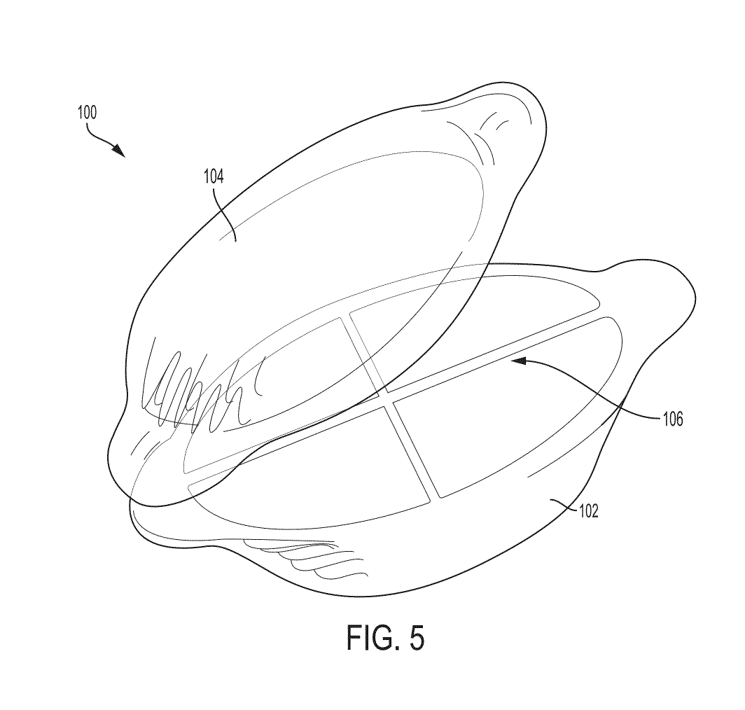

As shown in FIG. 1, in some embodiments, the container 102 and the lid 104 may be substantially dome-shaped. For example, the container 102 may have curved walls and a flat top, and the lid 104 also may have curved walls and a flat bottom. In some embodiments, the flat top of the container 102 and the flat bottom of the lid 104 allow for stable resting of the container 102 or lid 104, respectively, on a surface 108 (e.g., a kitchen counter or a food prep station). The container 102 and the lid 104 may have the same shape as one another in some embodiments, while in other embodiments, the container shape may differ from the lid shape. For example, as shown in FIG. 5, the container 102 may be substantially dome-shaped while the lid 104 may have a substantially flat shape.

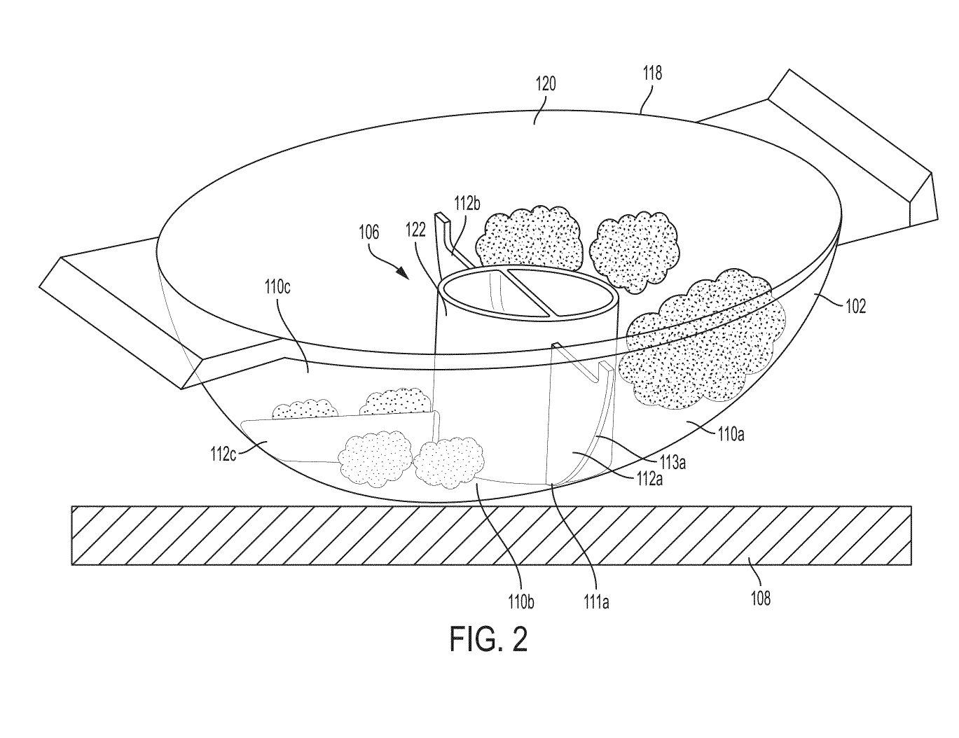

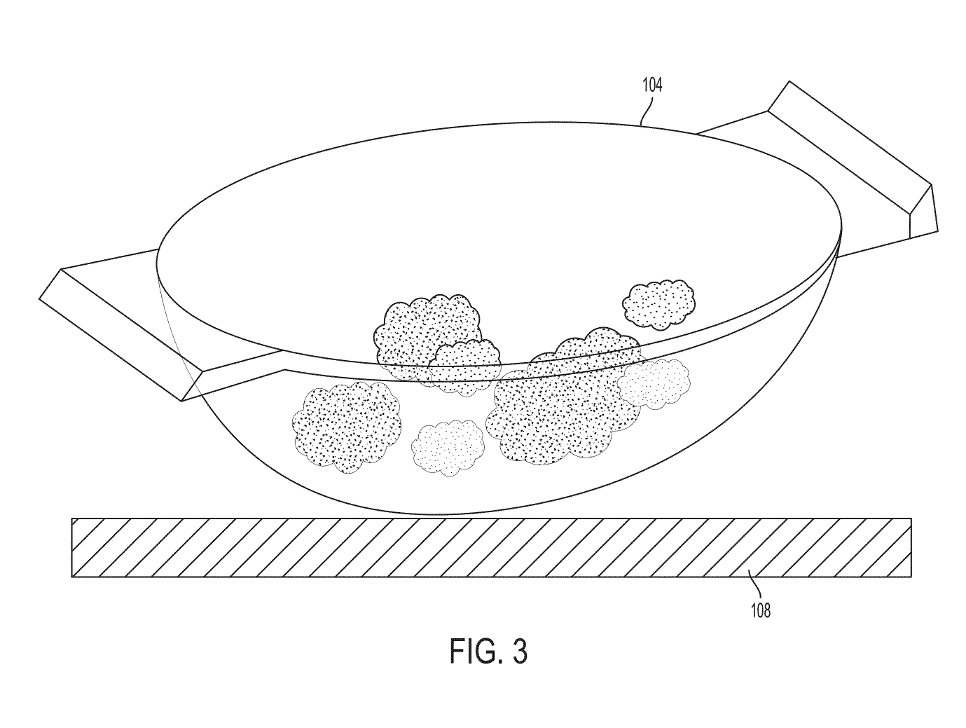

As illustrated in FIG. 2, the container 102 has a first section 110a for receiving a first food item, a second section 110b for receiving a second food item, and a third section 110c for receiving a third food item. The first, second and third sections 110a, 110b, 110c have first, second and third volumes, respectively. The first, second and third volumes correspond to target volumes of the first, second and third food items, respectively. Although three sections are shown in this figure, it should be appreciated that the container 102 may have more or fewer sections in other embodiments, depending upon the food dish that is being prepared. For example, while the dish being prepared in FIG. 2 uses three food items, other food dishes may include more or fewer food items, and, thus, the container 102 may have more or fewer sections.

In some embodiments, the volumes of the first, second and third sections 110a, 110b, 110c may be the same, while in other embodiments the section volumes may vary from section to section. For example, as shown in FIG. 2, the volumes of the second and third sections 110b, 110c are substantially the same, while the volume of the first section 110a is different. As will be appreciated, the volume of each section may vary depending upon the target volume of a specific food item in the food dish.

In some embodiments, the lid 104 has a volume, which in some embodiments is equal to or greater than the sum of the volumes of the first, second and third sections 110a, 110b, 110c of the container 102. In such embodiments, the lid may be used to serve and/or store the prepared food after mixing. As will be appreciated, the volume of the lid 104 may be larger or smaller depending upon the number of sections in the container 102 and the volume of each section. The lid 102 also may be configured to have substantially no volume and, thus, be unable to accommodate the food items in some embodiments. In some embodiments, the container 102 and the lid 104 together define a volume, which is sized to accommodate the first, second and third food items when the items are being mixed together. For example, in an embodiment in which the lid 104 is substantially flat, like that shown in FIG. 5, the combined volume of the lid 104 and the container 102 may be used for mixing the first, second and third food items. As will be appreciated, a user does not have to use the entire combined volume for mixing the food items. For example, in some embodiments, the user only uses the lid portion of the combined volume for mixing the food items, while in other embodiments the user only uses the container portion of the combined volume.

As shown in FIG. 2, the first, second and third section 110a, 110b, 110c of the container are defined, at least in part, by the divider 106. In some embodiments, the divider 106 has one or more partitions, which at least in part define the container sections. For purposes herein, a partition may include a wall or other structure suitable for separating areas of the container from one another. For example, in some embodiments, the partition may include a double-walled structure, a mesh-covered frame, or other suitable structures.

As illustrated in FIG. 2, in one embodiment, the first section 110a of the container 102 is defined by the first and second partitions 112a, 112b, the second section 110b is defined by first and third partitions 112a, 112c and the third section 110c is defined by second and third partitions 112b, 112c. Although three partitions are shown in this embodiment, in other embodiments, the divider 106 may have more or fewer partitions.

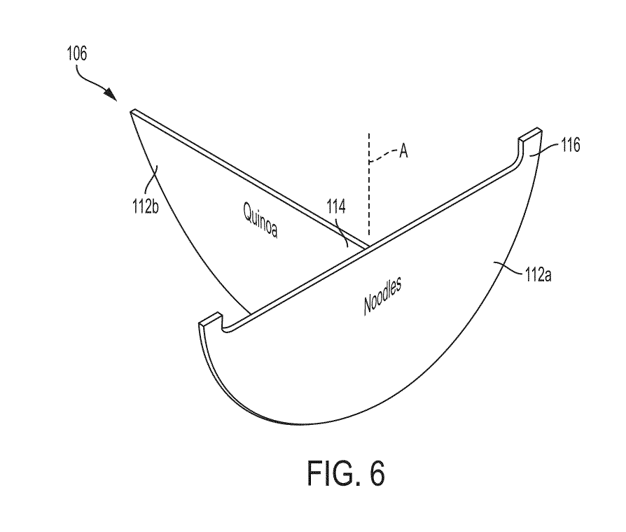

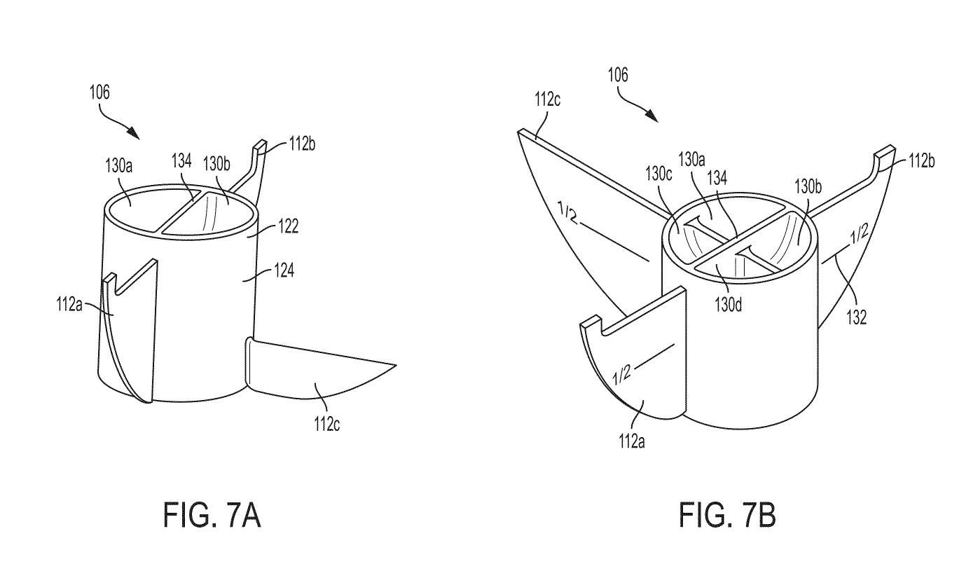

In some embodiments, the number of partitions is the same as the number of container sections. For example, in FIGS. 2 and 7A-7B, the divider 106 has three partitions, which, when positioned within the container, define three container sections. It should be appreciated that the number of container sections and the number of partitions 112 also may differ. For example, in FIG. 6, the divider 106 has two partitions 112a, 112b, but when the divider 106 is positioned within the container 102, the container has three sections.

As shown in FIG. 6, in some embodiments, the partitions are directly connected to one another and intersect along an axis A. Although the axis A is located substantially at a central portion of the first partition 112a in this embodiment, it should be understood that the second partition 112b may intersect the first partition 112a at other suitable locations in other embodiments. For example, in some embodiments, a first end 114 of the second partition 112b may be connected to a first end 116 of the first partition 112a.

In some embodiments, the partitions are permanently attached to one another. For example, in some embodiments, the partitions may be integrally formed or may be connected with a substantially permanent attachment method (e.g., with an adhesive). In other embodiments, the partitions may be removably attached to one another to allow for adjustment of the container sections defined by the partitions.

In some embodiments, the height and shape of the partitions may be the same as one another, while in other embodiments, the height and shape of each partition may vary from partition to partition. For example, as shown in FIGS. 2 and 7A-7B, the first partition 112a may have the same height and shape as another partition (e.g., the second partition 112b), although the height and shape of the first partition 112a also may differ from the height of another partition (e.g., the third partition 112c). In some embodiments, each of the partitions has a different shape and/or height as compared to the other partitions.

As previously described, the volume of the lid 102 and/or the combined volume of the container 102 and the lid 104 allows for mixing of the food items. In some embodiments, this combined volume is accomplished by having a lid 104 sized to accommodate the food items (e.g., the volume of the lid 104 is equal to or greater than the volume of the first and second sections). In other embodiments, this combined volume is accomplished at least in part by adjusting the height and position of the divider 106 with respect to the container 102. As shown in FIGS. 1 and 2, the divider 106, including each partition, does not reach a rim 118 of the container 102. Stated differently, the upper surface of the divider 106, including the upper surface of each partition, is located below the rim 118 of the container 102. In such an embodiment, irrespective of the size of the lid 104 and/or whether the divider 106 is first removed from the container 102, the food items are able to travel from partition to partition during mixing, thus allowing the food items to be combined.

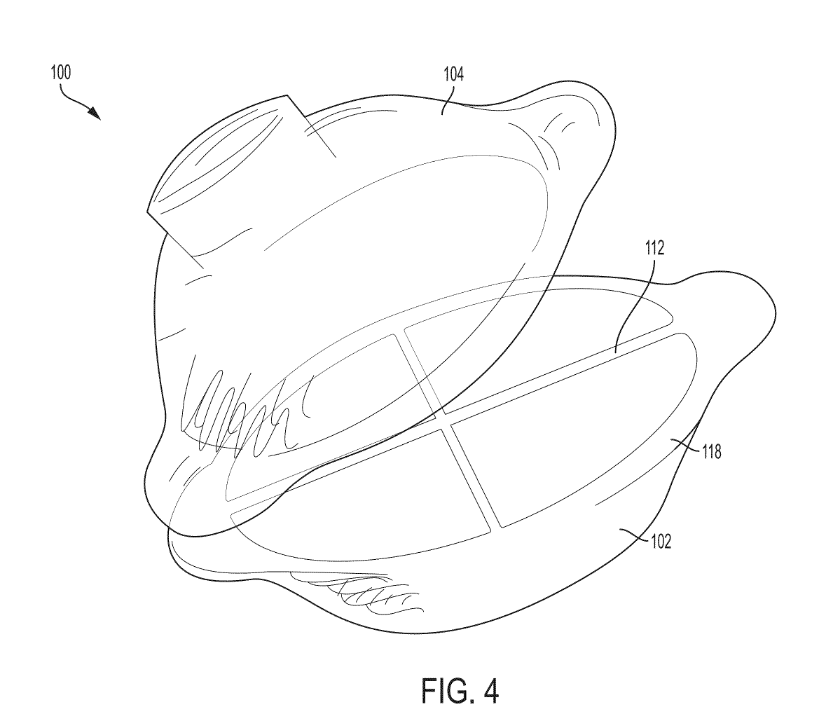

In other embodiments, as shown in FIG. 4, the divider 106, including each partition, reaches the rim 118 of the container 102. In such embodiments, to allow for mixing of the food items, the lid 104 includes a volume that is sized to receive at least a portion of the food items. The volume of the lid 104 thus allows the food items to travel between container sections during the mixing process.

In some embodiments, to maintain the food items in the respective container sections prior to mixing, thus allowing for consistent measurement of the food items, the divider 106 is configured to have a corresponding relationship with the container 102. Stated differently, in some embodiments, the divider 106 is shaped such that a bottom and side of each partition (e.g., exterior surfaces of each partition) extend along the interior surface 120 of the container 102 (see FIG. 2). That is, the shape of the bottom of the partitions may correspond to the shape of the bottom of the container 102, and the shape of the side of the partitions may correspond to the shape of the walls of the container 102. As shown in FIG. 2, an embodiment in which the container 102 has curved walls and a flat bottom, the first partition 112a has a corresponding flat bottom 111a and a curved side 113a.

In some embodiments, such as the ones shown in FIGS. 2 and 7A, the divider 106 also includes a partition support 122 to support the partitions and to hold additional food items. As shown in FIG. 7A, the partitions may extend outwardly from an exterior surface 124 of the partition support 122. In some embodiments, the partitions may extend substantially orthogonally from the exterior surface 124 of partition support 122. The partitions also may extend outwardly from the exterior surface 124 of the partition support 122 at other suitable angles. For example, in some embodiments, the partitions extend outwardly from the partition support 122 at an angle of between about zero (0) degrees and about one hundred and eighty (180) degrees. As will be appreciated, the extension angle chosen for each partition may correspond to the size of the container section 110 desired to accommodate the target volume of the particular food item used in the food dish.

Although the partition support 122 is shown as being located substantially in the center of the partitions and, thus, substantially in the center of the container 102 when the divider 106 is positioned in the container 102, it should be appreciated that the partition support 122 may be located in other suitable positions depending upon the configuration of the divider 106. For example, in one embodiment, the partition support 122 may be positioned against the interior surface 120 of the container 102, with the partitions extending outwardly from the partition support 122 and into a center of the container 102. In another embodiment, the partitions may be attached to one another as shown in FIG. 6, with the partition support 122 attached to only one of the partitions.

As previously mentioned, the partition support 122 may be configured to hold additional food items. As shown in FIGS. 7A and 7B, the partition support may include a plurality of compartments into which food items may be added. For purposes herein, a compartment may include any structure suitable for holding a food item to be combined using the food preparation system. As should be appreciated, the compartments do not need to be a closed structure. Also, the compartments need not extend the full height of the partition support 122. That is, the compartments may extend only a portion of the height of the partition support. In the embodiment shown in FIG. 7A, the partition support 122 has two compartments 130a, 130b for holding food items (e.g., fourth and fifth food items). The partition support 122 also may include more of fewer compartments for holding food items. For example, in the embodiment shown in FIG. 7B, the partition support 122 has four compartments 130a, 130b, 130c, 130d for holding food items.

In some embodiments, as is shown in FIGS. 7A and 7B, the compartments of the partition support 122 may be formed at least in part by dividing walls 134. For purposes herein a dividing wall may include any structure suitable for separating areas of the partition support from one another. For example, the dividing wall may be a single or double-walled structure, a mesh-covered frame or other suitable structures. As with the partitions, the dividing walls 134 may have the same heights and shapes as one another in some embodiments, while in other embodiments, the dividing walls 134 may have different heights and shapes from one another. In a similar fashion, the compartments in the partition support 122 may be the same size in some embodiments, while in other embodiments, the sizes of the compartments may vary from compartment to compartment. Each compartment of the partition support 122 has a volume. The volume of each compartment may be sized to accommodate a target volume of a food item used to prepare the food dish. For example, in the embodiment described above in which a Caesar salad is being prepared, one of the compartments may be sized to accommodate a volume of salad dressing corresponding to the single-sized portion of Caesar salad. The compartments also may be sized to accommodate a volume of ingredients used to form a salad dressing or sauce (e.g., a first compartment for oil and a second compartment for vinegar).

In some embodiments, as shown in FIGS. 7A and 7B, the partition support 122 has a substantially cylindrical shape. It should be appreciated that in other embodiments, the partition support 122 may have other suitable shapes.

Similar to the partitions, the shape of the bottom of the partition support 122 may be configured to correspond to the shape of the interior surface 120 of the container. For example, as is shown in FIGS. 2 and 7A-7B, the partition support 122 may have a flat surface, which corresponds to the flat bottom of the container 102. The bottom surface of the partition support 122 also may have other suitable shapes as this aspect of the disclosure is not limited in this regard. For example, in embodiments in which the partition support 122 is positioned against the curved side wall of the container 102, the bottom of the partition support 122 may have a corresponding curved shape.

As previously described, the container sections and partition support compartments may be used to measure the required food items for a particular dish. In some embodiments, the food preparation system 100 is configured such that a user need not know the exact volume of each food item needed (e.g., that two cups of lettuce are needed to prepare a Caesar salad). Instead, the user need only know that a first container section 110a corresponds to a particular food item (e.g., lettuce) and that the first container section 110a should be filled to a set volume to prepare the dish. As such, measuring the food item may include adding the specific food item to the container section or partition support compartment until the food item reaches an indicator. In some embodiments, this measurement involves adding the food item until the container section and/or the partition support compartment is completely filled (e.g., when the food item reaches a top of the container section and/or the partition support compartment). In some embodiments, as shown in FIG. 6, each partition may be labeled with the name of the corresponding food item (e.g., noodles or quinoa).

In other embodiments, the food preparation system 100 is configured to prepare various sizes of the same food dish (e.g., a side salad and/or an entrée-sized salad), and the food items are added until the food items reach the indicator. The system 100 also may be configured such that the user can vary the ratios of the food items (e.g., using only half of the target volume of salad dressing). In these embodiments, as with other embodiments, the user need not know the exact volume required for a particular food item. Instead, the user need only know that a particular section and/or compartment corresponds to a specific food item and which size of the dish is being prepared (e.g., a full portion or a half-sized portion) of the food dish.

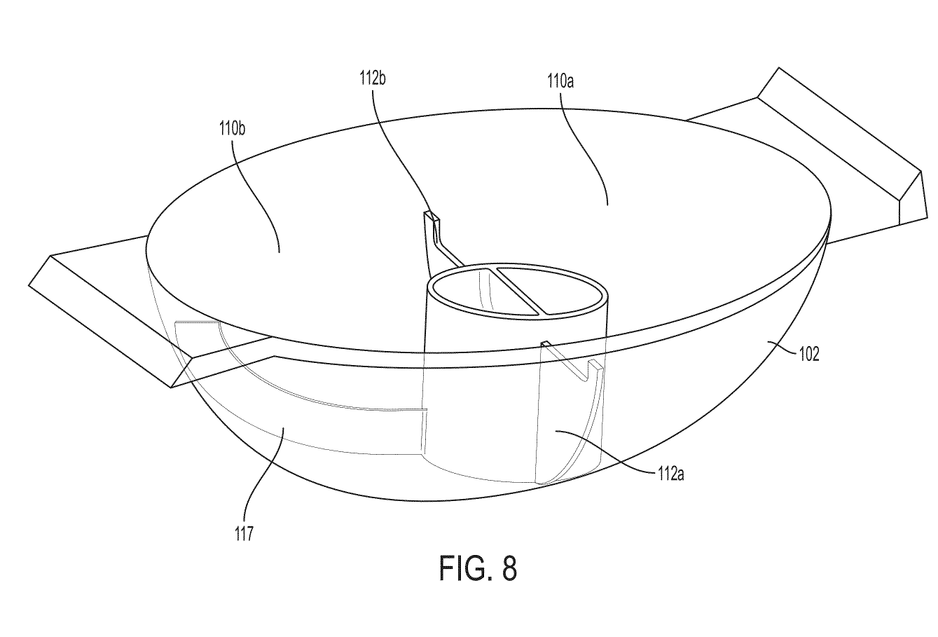

In some embodiments, to prepare different portions sizes of the food dish, the divider 106 is configured to create container sections corresponding to the different portions sizes (e.g., half and full size portions). For example, in the embodiment shown in FIG. 8, the divider 106 has first and second partitions 112a, 112b, which, when the divider 106 is inserted into the container, form first and second container sections 110a, 110b. As shown in FIG. 8, the divider 106 also has a support 117, which helps maintain the divider in the desired position in the container 102 but which does not create a container section. In these embodiments, the volume of the first section 110a is equal to the volume of the second section 110b, and each section independently corresponds to a half-sized portion of the food dish. As will be appreciated, the combined volume of the first and second sections corresponds to the full-sized portion of the food dish. In such an embodiment, to prepare the half-sized portion, the user fills either the first or second container section 110a, 110b with the selected food item, and thereafter adds any other food items required for the food dish. To prepare a full-sized portion, the user fills both the first and second sections of the container with the food item, and thereafter adds any other foods items required for the food dish.

In other embodiments, to denote the different portion sizes that can be prepared for a particular food dish using the system 100, the container and/or the divider 106 has one or more indicators. In embodiments having a plurality of indicators 132 (see FIG. 7B), it should be appreciated that the number of indicators 132 on each partition may differ. That is, each partition may include a single indicator 132 or multiple indicators 132. For example, in the embodiment shown in FIG. 7B, the first and second partitions 112a, 112b may each have one indicator 132, while, in other embodiments, at least one of the partitions may have more than one indicator 132. Also, while the indicators 132 are shown on the divider 106 in this embodiment, the indicators also may be positioned on the interior surface 120 of the container 102.

The types of indicators 132 used by the system 100 may vary from divider to divider or may vary from system to system. For example, as illustrated in FIG. 7B, indicators 132 may be located at and have labels corresponding to a half-sized portion of the food dish. In other systems 100, the indicators may be located at and may include labels that correspond to quarter, three-quarter, full or double sized portions of the food dish. The indicators 132 also may indicate volumetric measurements (e.g., ¼ cup, ½ cup and ¾ cup) in other embodiments.

In some embodiments, the divider may be removably positionable within the container. In such embodiments, the divider 106 may be positioned within the container 102 to measure the food items and then removed from the container 102 prior to mixing. This removability may facilitate mixing of the food items and/or cleaning of the food preparation system 100. The divider 106 also may be removed from the container only after the food items have been combined and removed from the container 102 for serving, as the presence of the partitions also may facilitate mixing in some embodiments (e.g., coating of the dry ingredients with the wet ingredients). In some embodiments, the divider 106 may be removably attached to the container 102. In one embodiment, the divider 106 may have a snap-fit engagement with the container 102.

In some embodiments, as illustrated in FIG. 1, the interior surface 120 of the container has a groove or partition track 136 into which a partition of the divider 106 is received. As will be appreciated, the shape of the partition track 130 corresponds to the shape of the partition. The interior surface 120 of the container 102 also may have protrusions 138 at the top of each partition track 136 for maintaining the partition in the groove 136 and, thus, in the container 102. As shown in FIG. 1, the partitions may have a corresponding tab 144 at an upper end for engagement with the protrusion 138.

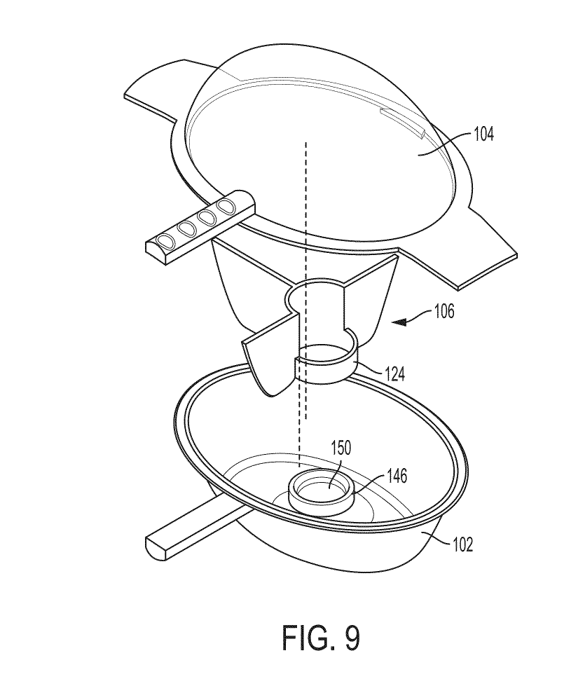

According to another embodiment, as shown in FIG. 9, the partition support 124 may be engaged with the container 102. In some embodiments, the partition support 124 is placed around an engagement portion 146 of the container 102, which positions the divider 106 in the container 102 for measuring. In some embodiments, the engagement portion 146 also prevents rotation of the divider 106 within the container. As shown in FIG. 9, the engagement portion 146 also may include a compartment 150, which may be used to hold additional food items.

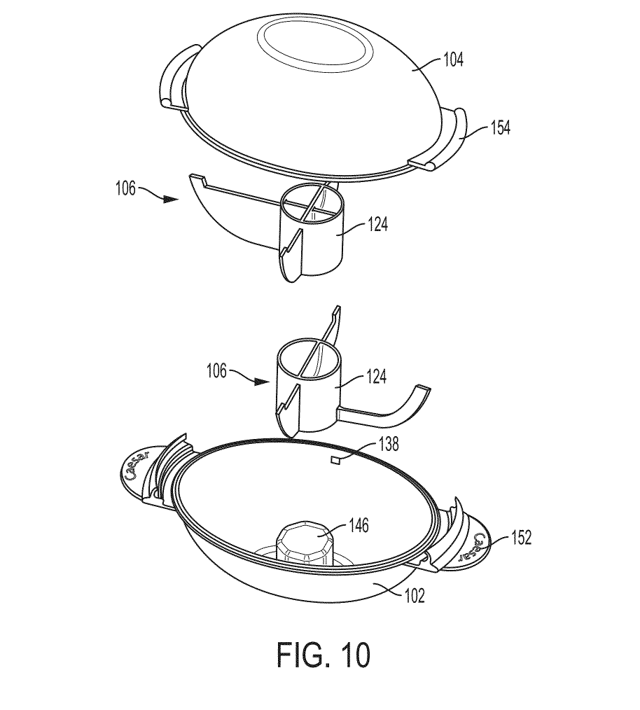

As shown in FIG. 10, in some embodiments, the engagement portion 146 of the container 102 includes a stump over which the partition support 124 is placed. As with the embodiment shown in FIG. 9, the engagement portion 146 in this embodiment also may limit the rotation of the divider 106 within the container. As will be appreciated, the container 102 also may have protrusions 138 in such embodiments for maintaining the divider 106 in the container.

In embodiments in which the divider 106 is removably positionable within the container 102, the food preparation system 100 may include a plurality of removable dividers 106, each divider 106 corresponding to a particular food dish that can be prepared. Such an embodiment is shown in FIG. 10, for example, which has one container 102 and two corresponding dividers 106. In such an embodiment, each divider 106 is configured to define sections of the container for each of the food items used for a particular dish. In some embodiments, the food preparation system 100 includes a single container 102 that is configured to receive each of the plurality of dividers 106 and to allow the user to prepare several different dishes using the same container 102. The user also may use several containers 102, each container being able to receive at least one of the removable dividers 106. In some embodiments, each divider 106 may be labeled with the name of the food dish that the divider is configured to prepare. In other embodiments, the divider 106 may be permanently attached to the container 102. In one embodiment, the divider 106 and the container 102 may be integrally formed, although other methods of permanently attaching the divider 106 to the container 102 may be used as this aspect of the disclosure is not limited in this regard. For example, in some embodiments, the divider 106 may be adhered or otherwise substantially permanently affixed to the interior surface of the container 102.

In embodiments in which the divider 106 is permanently attached to the container 102, several food preparation systems 100 may be configured and used to prepare different food dishes. For example, a first food preparation system 100 may be used to prepare a Caesar salad, whereas a second food preparation system 100 may be used to prepare a garden salad. In these embodiments, each container is configured to accurately portion the food items used for the particular dish. In some embodiments, the container 102 may be labeled with the name of a food dish which the container is used to prepare.

In some embodiments, a seal is formed between the container 102 and the lid 104 when the lid 104 is attached to the container. In some embodiments, a liquid-tight seal is formed between the container 102 and the lid 104. These configurations may help the user maintain the food items inside the volume defined by the container 102 and the lid 104 when the food items are being combined. In some embodiments, one of the container 102 and the lid 104 has a gasket 140, which is arranged to abut against the other of the lid 104 and container 102, respectively, to create the seal. In one embodiment, as shown in FIG. 1, the gasket 140 is arranged on a rim of the lid 104 and abuts against the rim of the container 102. It should be appreciated that other configurations for forming a seal, or a liquid-tight seal, between the lid 104 and the container 102 for maintaining the food items within the volume of the container 102 and the lid 104 may be used as this aspect of the disclosure is not limited in this regard.

As shown in FIGS. 1 and 10, in some embodiments, the container and/or the lid has handles 152, 154 that a user may grasp while preparing the food dish. In some embodiments, the container 102 and the lid 104 each have two handles 152, 154, as is shown, while in other embodiments, the container 102 and the lid 104 may each have one handle or more than two handles. In some embodiments, like that shown in FIG. 1, the handles 152, 154 are substantially rectangular in shape. The handles also may be curved and extend outwardly from the container 102 and/or lid 104.

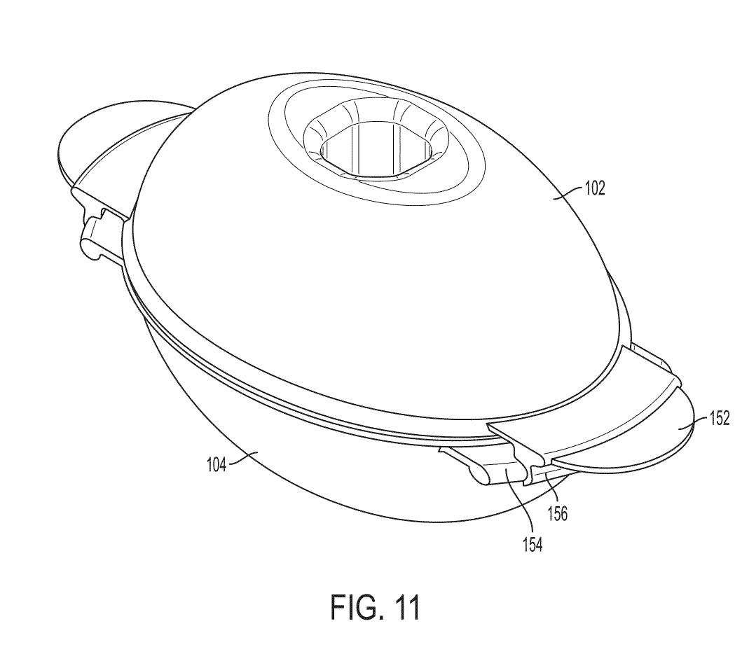

In some embodiments, the handles 152, 154 of the container 102 and lid 104 are the same shape and size, while in other embodiments, the shape and size of the container handle 152 may be different than the shape and size of the lid handle 154. As shown in FIG. 11, for example, in some embodiments the container handle 152 may be longer and narrower than the lid handle 154. In such embodiments, the different shapes and sizes of the container handle 152 and lid handle 154 may assist with securing and/or separating the lid 104 and container 102. For example, by having the container handle 152 extend outwardly from an engagement member 156 by at least one inch, a grip area is available to the user. Additionally, by having the container handle 152 extend away from the container 102 by at least three inches, the user has a mechanical advantage when bending the container handle 152 to remove it from the lid handle 154.

In some embodiments, the handles 152 on the container 102 engage with the handles 154 on the lid to secure the lid 104 to the container 102. In some embodiments, the handles 154 on the lid 104 have a snap-fit engagement with the handles 154 on the container 102. In such embodiments, as shown in FIG. 1, the engagement member 156 may include a capturing portion 157, which moves outwardly when contacted by the lid handle 154 via bending of the container handle 152, and returns to its original position once the lid 104 is placed on the container 102, thus capturing the lid handle 154. To disconnect the lid from the container, the container handles 152 are flexed in an outward direction to disengage the lid handle 154 from the capturing portion 157. The lid 104 can thereafter be separated from the container 102. As should be appreciated, although the container handles 152 are shown as having the capturing portion in this embodiment, in other embodiments, the lid handles 154 may have other engagement members for engaging the container handles 152.

In another embodiment, the lid handles 154 and the container handles 152 have a sliding engagement. For example, to secure the lid 104 to the container 102, the lid 104 is placed on the container 102 and is turned in a clockwise direction, thus engaging the lid handles 154 with the container handles 152. In such an embodiment, the lid 104 may be disconnected from the container 102 by turning the lid 104 in a counter-clockwise direction, thus disengaging the lid handles 154 from the container handles 152. As will be appreciated, although the lid handles engage with the container handles in a clockwise direction in this embodiment, in other embodiments, the lid handles may engage with the container handles in a counter-clockwise direction and disengage by moving the lid in a clockwise direction.

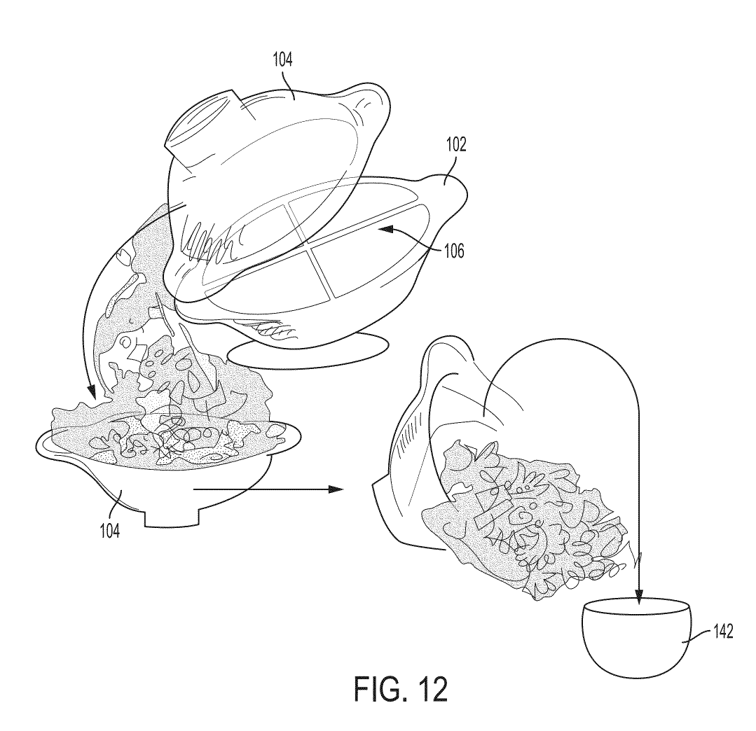

According to another embodiment, a method of preparing a food dish is disclosed. In some embodiments, the method includes selecting a first divider corresponding to the particular food dish to be prepared. The method further includes positioning the first divider within the container, the container having first and second sections that are defined at least in part by the first divider, adding food items to at least one of the first and second sections, and mixing the food item. In some embodiments, the method further comprises attaching a lid to the container and mixing the food items within the volume defined by the lid and the container. As will be appreciated, for embodiments in which the divider is permanently attached to the container, the method may include selecting a first container that corresponds to the particular food dish to be prepared, adding the food items to at least the first and second sections, attaching the lid, and mixing the food items. In some embodiments, as shown in FIG. 12, the method further includes inverting the container 102 so that the food items are transferred to the lid 104. The combined food items can thereafter be transferred from the lid 104 to a plate or tray 142 for serving or eating the food dish.

According to another embodiment, a method of combining food items using a container and a divider is disclosed. The divider includes a partition support with at least two compartments and a first partition connected to the partition support. The container has first and second sections for holding food items, the first and second sections defined at least in part by the divider. The method includes adding a first food item to at least one of the partition support compartments, adding a second food item to at least one of the first and section sections, and mixing the food items. In some embodiments, the method further includes attaching the lid to the container and mixing the food items within a volume defined by the container and the lid.

As will be appreciated, food items need not be added to each of the container sections formed by the divider. That is, a first food item may be added to the first container section, a second food item may be added to a second container section, and the third container section may be left empty. As will also be appreciated, food items may be added to the container without being measured by or added to a specific container section. For example, croutons may be added to and spread across several container sections. In such embodiments, a user may decide to omit an ingredient from a food dish or may decide to add additional ingredients to the food dish.

Although embodiments are shown and described as using the divider to prepare the food dish, in some embodiments, the food dish may be prepared by adding first and second food items directly to the container (e.g., to the container without a divider). In such embodiments, once the food items are added, the lid may be attached to the container and the food items may be mixed within the volume defined by the container and the lid.

While the present teachings have been described in conjunction with various embodiments and examples, it is not intended that the present teachings be limited to such embodiments or examples. On the contrary, the present teachings encompass various alternatives, modifications, and equivalents, as will be appreciated by those of skill in the art. Accordingly, the foregoing description and drawings are by way of example only.

What is claimed is:

1. A method of combining food items using a container and a divider positioned in the container to form container sections, the method comprising:
adding a first food item to a first section of the container until the first food item reaches a first indicator on one of the container and the divider;
adding a second food item to a second section of the container until the second food item reaches a second indicator on one of the container and the divider;
attaching a lid to the container;
mixing the food items within a volume defined by the container and the lid.

2. The method of claim 1, wherein:
adding the first food item to the first section of the container until the first food item reaches a first indicator comprises adding the first food item to the first section of the container until the first food item reaches a top of a wall of a partition of the divider; and
adding the second food item to the second section of the container until the second food item reaches the second indicator comprises adding the second food item to the second section of the container until the second food item reaches the top of the wall of the partition of the divider.

3. The method of claim 1, further comprising removing the divider from the container prior to mixing the food items, the first and second sections being defined at least in part by the divider.

4. The method of claim 1, wherein mixing the food items comprises inverting the container such that the food items move into the lid.

5. An apparatus for combining food items, the apparatus comprising:
a container;
a first removable divider;
a second removable divider distinct from the first removable divider, the container being arranged to hold one of the first and second removable dividers at a time; and
a lid attachable to the container;
wherein the first removable divider includes a first partition arrangement which defines at least in part first and second container sections;
wherein the second removable divider includes a second partition arrangement which defines at least in part third and fourth container sections, the second partition arrangement being different from the first partition arrangement;
wherein the first section has a first volume, the second section has a second volume, the third section has a third volume, and the fourth section has a fourth volume;
wherein the lid has a volume equal to or greater than a sum of the first and second volumes, and the lid has a volume equal to or greater than a sum of the third and fourth volumes.

6. The apparatus of claim 5, wherein each of the first and second removable dividers is removably positionable within the container.

7. The apparatus of claim 6, wherein each of the first and second removable dividers is removably attachable to the container.

8. The apparatus of claim 7, wherein each of the first and second removable dividers has a snap-fit engagement with the container.

9. The apparatus of claim 5, wherein the lid has curved walls and a flat top.

10. The apparatus of claim 5, wherein the lid forms a seal with the container when the lid is attached to the container.

11. The apparatus of claim 10, wherein the lid forms a liquid-tight seal with the container when the lid is attached to the container.

12. The apparatus of claim 10, wherein at least one of the container and the lid has a gasket arranged to abut the other of the container and the lid when the lid is attached to the container.

13. The apparatus of claim 5, wherein the first volume is different from the second volume, and the third volume is different from the fourth volume.

14. The apparatus of claim 5, wherein the first removable divider includes a first partition and a first partition support, and the second removable divider includes a second partition and a second partition support; wherein the first and second partitions extend outwardly from the first and second partition supports, respectively.

15. The apparatus of claim 14, wherein the first and second partition supports each comprise at least two compartments.

16-18. (canceled)

19. The apparatus of claim 5, wherein a first partition of the first removable divider does not reach to a rim of the container when the first removable divider is attached to the container, and a second partition of the second removable divider does not reach to the rim of the container when the second removable divider is attached to the container.

20. (canceled)

21. The apparatus of claim 5, wherein an exterior surface of each of the first partition arrangement and the second partition arrangement extends along an interior surface of the container.

22. The apparatus of claim 21, further comprising at least one partition track on the interior surface of the container to receive the first or second partition arrangement.

23-44. (canceled)

45. A method of combining food items using a container and a plurality of removable dividers, the method comprising:
selecting a first divider;
positioning the first divider within the container such that the container has first and second sections to hold food items, the first and second sections being defined at least in part by the first divider;
adding food items to each of the first and second sections; and
mixing the food items.

46. The method of claim 45, further comprising attaching a lid to the container, wherein mixing the food items comprises mixing the food items within a volume defined by the container and the lid.

47. The method of claim 46, further comprising inverting the container such that the food ingredients move into the lid.

48. (canceled)

49. The method of claim 45, further comprising removing the divider from the container prior to mixing the food ingredients.

50. The method of claim 45, further comprising:
removing the mixed food items and the first divider from the container;
selecting a second divider, the container having third and fourth sections to hold food items, the third and fourth sections being defined at least in part by the second divider;
positioning the second divider within the container;
adding food items to at least one of the third and fourth sections; and
mixing the food items.

51. The method of claim 50, further comprising attaching a lid to the container, wherein mixing the food items comprises mixing the food items within a volume defined by the lid and the container.

52-55. (canceled)
